(19) United States
(12) Patent Application Publication
(10) Pub. No.: US 2021/0144348 A1
(43) Pub. Date: May 13, 2021

(54) PROJECTOR APPARATUS, METHOD FOR CONTROLLING PROJECTOR APPARATUS, PROGRAM, AND RECORDING MEDIUM

(71) Applicant: Sharp Fukuyama Semiconductor Co., Ltd., Fukuyama City (JP)

(72) Inventors: MITSUHIRO MATSUMOTO, Fukuyama City (JP); NORIAKI FUJII, Fukuyama City (JP); TAKATOSHI MORITA, Fukuyama City (JP); KENGO YAMASAWA, Fukuyama City (JP)

(21) Appl. No.: 17/087,163

(22) Filed: Nov. 2, 2020

(30) Foreign Application Priority Data
Nov. 8, 2019 (JP) 2019-203449

(51) Int. Cl. H04N 9/31; G01S 17/08; G01C 3/02

(52) U.S. Cl. CPC H04N 9/3194; H04N 9/3129; G01C 3/02; G01S 17/08; H04N 9/3185

(57) ABSTRACT

A projector apparatus includes a projection unit that projects an image on a projection target, a distance-measuring unit that measures a distance from an emitting end of the projection unit to the projection target, and a control unit that sets a luminance of projection light to a predetermined constant value when a distance measured by the distance-measuring unit is equal to or smaller than a predetermined distance and increases the luminance of the projection light such that the luminance does not exceed a set luminance of the projection light corresponding to the measured distance when the distance measured by the distance-measuring unit is larger than the predetermined distance.

### BACKGROUND

### 1. Field

The present disclosure relates to a projector apparatus, a method for controlling a projector apparatus, a program, and a recording medium.

### 2. Description of the Related Art

The following technology is known in the field of projector apparatuses. The intensity per unit area of projection light is high in the vicinity of a projection aperture of a projection unit of a projector. Thus, there is a demand for a further enhancement of safety for users. Accordingly, a distance-measuring unit is provided in a projector so as to measure the distance from a projection aperture of a projection unit to an object to be measured, and when the measured distance is equal to or smaller than a safe distance, it is determined to be an unsafe area. When an object to be measured is located in the unsafe area, the intensity of projection light is reduced, or the projection light is turned off (Japanese Unexamined Patent Application Publication No. 2014-174194 (published Sep. 22, 2014)).

In recent years, a technology for using a projector in projection mapping has been developed. When the optical axis of projection light emitted from a projector is not perpendicular to a projection surface, an image that is projected on the projection surface is distorted, and thus, distortion correction is performed. More specifically, the image distortion is corrected by calculating the distance to the projection surface (Japanese Unexamined Patent Application Publication No. 2019-20439 (published Feb. 7, 2019)).

However, in Japanese Unexamined Patent Application Publication No. 2014-174194, a projected image is enlarged when the distance from the projection unit of the projector to an object to be measured increases. In this case, there is a problem in that the brightness per unit area of the projected image decreases.

In addition, in Japanese Unexamined Patent Application Publication No. 2019-20439, there is a problem in that unevenness in the brightness of a projected image is generated because, in projection mapping, the brightness per unit area of a projected image differs between a portion of a projection surface that is spaced apart from a projection unit by a small distance and a portion of the projection surface that is spaced apart from the projection unit by a large distance.

If the luminance of a projection unit of a projector is increased in order to address the above problems, there is a possibility that projection light may affect the safety of users.

The present disclosure provides a projector apparatus capable of suppressing a decrease in the brightness of a projected image and ensuring safety for users even if the distance from a projection unit of the projector apparatus to a projection surface increases.

### SUMMARY

According to a first aspect of the present disclosure, there is provided a projector apparatus including a projection unit that projects an image on a projection target, a distance-measuring unit that measures a distance from an emitting end of the projection unit to the projection target, and a control unit that sets a luminance of projection light to a predetermined constant value when a distance measured by the distance-measuring unit is equal to or smaller than a predetermined distance and increases the luminance of the projection light such that the luminance does not exceed a set luminance of the projection light corresponding to the measured distance when the distance measured by the distance-measuring unit is larger than the predetermined distance.

According to a second aspect of the present disclosure, there is provided a method for controlling a projector apparatus including projecting an image on a projection target, measuring a distance from an emitting end of a projection unit, which is used in the projecting, to the projection target, and setting a luminance of projection light to a predetermined constant value when a distance measured in the measuring is equal to or smaller than a predetermined distance and increasing the luminance of the projection light such that the luminance does not exceed a set luminance of the projection light corresponding to the distance measured in the projecting when the measured distance is larger than the predetermined distance.

### BRIEF DESCRIPTION OF THE DRAWINGS

FIG. 1 is a diagram illustrating projection performed onto a projection target by a projector apparatus according to a first aspect of the present disclosure;

FIG. 2 is a block diagram illustrating a principal portion of the projector apparatus illustrated in FIG. 1;

FIG. 3 is a graph illustrating a relationship between the distance from a projection unit of the projector apparatus illustrated in FIG. 1 to the projection target and the luminance of the projection unit;

FIG. 4 is a diagram illustrating projection performed onto a projection target by a projector apparatus according to a second aspect of the present disclosure;

FIG. 5 is a diagram illustrating projection performed onto a projection target by a projector apparatus according to a third aspect of the present disclosure;

FIG. 6 is a diagram illustrating projection performed onto a projection target by a projector apparatus according to a fourth aspect of the present disclosure;

FIG. 7 is a diagram illustrating projection performed onto a projection target by a projector apparatus according to a fifth aspect of the present disclosure; and

FIG. 8 is a diagram illustrating projection performed onto a projection target by a projector apparatus according to a sixth aspect of the present disclosure.

### DESCRIPTION OF THE EMBODIMENTS

### (Reference Technology and Preliminary Configuration Example)

Before specifically describing an embodiment of the present application, a reference technology and a preliminary configuration will be described as a supplementary explanation of the above-mentioned related art.

In a projector apparatus that projects an image onto a projection target by using a projection unit, it is necessary to ensure the safety of users against projection light of the projector. Accordingly, the international electrotechnical commission (IEC) has established safety class standards. A detector for evaluation is installed, on the basis of the standards, at a location that is spaced apart from an emitting end of the projection unit by a certain distance. The light output of the projection unit is set to be equal to or less than a maximum exposure emission standard set for each class, and the luminance of the projection unit of the projector is set accordingly.

The luminance of the projection unit of the projector is usually set to be constant and does not vary in accordance with the distance from the projection unit to a projection target.

### First Embodiment

A first embodiment of the present disclosure will now be described in detail with reference to FIG. 1 to FIG. 3.

The first embodiment will be described in order to embody the concept of the present disclosure, and the present disclosure is not limited to the first embodiment and the other embodiments, which will be described later.

FIG. 1 is a diagram illustrating projection performed onto a projection target 3 by a projector apparatus according to the first embodiment. As illustrated in FIG. 1, projection light 2 that is emitted from an emitting end of a projection unit 1 of the projector apparatus is projected onto the projection target 3. A distance-measuring unit 4 (a distance-measuring sensor 20) that measures a distance L1 from the emitting end of the projection unit 1 to the projection target 3 is built in the projection unit 1.

A projection surface of the projection target 3 is positioned so as to be substantially perpendicular to the optical axis of the projection light 2. In addition, the projection surface of the projection target 3 is a flat surface.

FIG. 2 is a block diagram illustrating a principal portion (projection unit 1) of the projector apparatus illustrated in FIG. 1. As illustrated in FIG. 2, the projector apparatus includes a housing 10 in which various optical modules and the distance-measuring sensor 20 are accommodated, a laser driver 25, and a control unit 24 that performs overall control of the projector apparatus.

More specifically, the distance-measuring unit 4 (distance-measuring sensor 20) is built in the projection unit 1. In the first embodiment, the projection unit 1 forms part of the projector apparatus that employs a laser-beam scanning system and that projects an image by scanning laser beams.

The optical modules accommodated in the housing 10 include a red-laser emitter 11, a first collimator lens 12, a green-laser emitter 13, a second collimator lens 14, a blue-laser emitter 15, a third collimator lens 16, a first beam splitter 17, a second beam splitter 18, and a micro electro mechanical system (MEMS) mirror 19 that is movable in two axial directions, which are a horizontal direction and/or a vertical direction.

The laser driver 25 includes a red-laser control unit 21, a green-laser control unit 22, and a blue-laser control unit 23. The red-laser emitter 11 emits a red laser beam by receiving power controlled by the red-laser control unit 21. The green-laser emitter 13 emits a green laser beam by receiving power controlled by the green-laser control unit 22. The blue-laser emitter 15 emits a blue laser beam by receiving power controlled by the blue-laser control unit 23.

The first collimator lens 12 causes the red laser beam emitted by the red-laser emitter 11 to become collimated light, and the collimated light passes through the first beam splitter 17 and the second beam splitter 18 and is incident on the MEMS mirror 19.

The second collimator lens 14 causes the green laser beam emitted by the green-laser emitter 13 to become collimated light, and the collimated light is reflected by the first beam splitter 17, passes through the second beam splitter 18, and is incident on the MEMS mirror 19.

The third collimator lens 16 causes the blue laser beam emitted by the blue-laser emitter 15 to become collimated light, and the collimated light is reflected by the second beam splitter 18 and is incident on the MEMS mirror 19.

The optical axes of the red laser beam, the green laser beam, and the blue laser beam, which are incident on the MEMS mirror 19, are optically aligned so as to coincide with one another, and the MEMS mirror 19 is caused to scan by the control unit 24, so that an image can be projected onto a projection target.

Although not particularly illustrated, an image processing unit that is included in the projector apparatus performs conversion processing so as to convert image data input from the outside into data items of three colors of red (R), green (G), and blue (B), and each of the converted data items is transmitted to a corresponding one of the red-laser control unit 21, the green-laser control unit 22, and the blue-laser control unit 23.

The description of the first embodiment will be continued below. In the first embodiment, the following configuration is employed in order to achieve both suppression of a decrease in the brightness of a projected image that is projected on the projection target 3 and ensuring of user safety. The distance-measuring sensor 20 measures the distance from the emitting end of the projection unit 1 (the right-hand end of the projection unit 1 in FIG. 1) to the projection target 3, and a reference distance (hereinafter also referred to as predetermined distance) is determined. At this point, the luminance of the projection unit 1 of the projector apparatus is set to the luminance according to the safety standards for laser products (IEC 60825-1) of the international electrotechnical commission. In the first embodiment, when the distance measured by the distance-measuring unit 4 is equal to or smaller than the reference distance, the control unit 24 sets the luminance of the projection light 2 to a predetermined constant value.

In contrast, when the distance from the emitting end of the projection unit 1 to the projection target 3 is increased to be larger than the reference distance, the projected image is enlarged. Along with the enlargement of the projected image, the brightness per unit area of the projected image decreases. If the luminance of the projection light 2 emitted by the projection unit 1 is increased in order to suppress a decrease in the brightness of the projected image, there is a possibility that the safety of users against the projection light 2 may be reduced.

Accordingly, in the first embodiment, when the distance from the emitting end of the projection unit 1 to the projection target 3 is larger than the reference distance, the control unit 24 calculates a maximum allowable luminance that corresponds to the measured distance and increases the luminance of the projection light 2 emitted by the projection unit 1 to be less than the maximum allowable luminance (a set luminance). As a result, even when the distance from the emitting end of the projection unit 1 to the projection target 3 is increased, suppression of a decrease in the brightness per unit area of the projected image projected on the projection target 3 and ensuring of the user safety can be both achieved.

(Relationship Between Luminance of Projection Unit and Distance from Projection Unit to Projection Target)

FIG. 3 is a graph illustrating a relationship between the distance from the projection unit 1 of the projector apparatus illustrated in FIG. 1 to the projection target 3 and the luminance of the projection unit 1. In FIG. 3, the maximum allowable luminance is indicated by a solid line, and a set luminance that is lower than the maximum allowable luminance is indicated by a dashed line.

When a distance that is measured by the distance-measuring unit 4 is larger than the reference distance, in the projector apparatus that employs a laser scanning system, the maximum allowable luminance of the projection light 2 corresponding to the above measured distance is obtained by calculating a maximum allowable exposure light output of a laser beam for each distance and calculating the maximum allowable luminance of the projection unit 1 corresponding thereto. The set luminance of the projection unit 1 may be set to be lower than the maximum allowable luminance so as to allow some leeway (e.g., by multiplying it by a predetermined coefficient). In the first embodiment, the set luminance for each measured distance larger than the reference distance is set to be 10% lower than the maximum allowable luminance for the corresponding measured distance and to be, at a maximum, 90% of the maximum allowable luminance.

In a projector of the related art, the luminance of a projection unit is set, regardless of a distance, in such a manner that the maximum allowable luminance is lower than 11 lumens at an evaluation distance of 100 mm based on the safety standards for laser products (see FIG. 3).

In contrast, in the projector apparatus according to the first embodiment, when a distance that is measured by the distance-measuring unit 4 after the reference distance has been determined increases, the set luminance is set for each distance as illustrated in FIG. 3. Since the set luminance is lower than the maximum allowable luminance, an adverse effect on the safety for users is suppressed.

In the first embodiment, as illustrated in FIG. 3, when a measured distance is within the range of 0 mm to 300 mm or 400 mm, the set luminance is set to 10 lumens. In addition, as illustrated in FIG. 3, the luminance of the projection light 2 emitted by the projection unit 1 increases substantially linearly for distances larger than the range of 300 mm to 400 mm, and the increase rate of the luminance is approximately 0.02 lumens/mm to 0.03 lumens/mm. The reference distance is set within a range of 300 mm to 400 mm, and when a measured distance is larger than the reference distance, the increase rate of the luminance is set to the above-mentioned increase rate, so that a system capable of ensuring both the brightness of a projected image on a projection target and safety for users can be designed relatively easily.

### Second Embodiment

A second embodiment of the present disclosure will now be described in detail with reference to FIG. 4. In the following description, elements that have functions the same as those of the elements in the above-described first embodiment will be denoted by the same reference signs for convenience of description, and descriptions thereof may sometimes be omitted.

In the second embodiment, the case of using a projector apparatus in projection mapping will be described. FIG. 4 is a diagram illustrating projection performed onto a projection target 103 by the projector apparatus according to the second embodiment. As illustrated in FIG. 4, in projection mapping, when projection light 102 is projected onto the projection target 103 that has a three-dimensional shape with irregularities, the brightness of a projected image at a portion of the projection target 103 that is spaced apart from a projection unit 101 by a large distance is low, and thus, there is a problem in that the brightness of the entire projected image is non-uniform.

As illustrated in FIG. 4, the projection light 102 from an emitting end of the projection unit 101 of the projector apparatus is projected on the projection target 103. A distance-measuring unit 104 measures the distance from the emitting end of the projection unit 101 to each portion of the projection target 103. A projection region 105 and a projection region 106 are respectively spaced apart from the projection unit 101 by a shortest distance L11 and a distance L12, and the luminance of the projection light 102 that is emitted by the projection unit 101 toward the projection region 106, which is spaced apart from the projection unit 101 by the distance L12 larger than the shortest distance L11, is increased so as to make the brightness of the projected image uniform.

In this case, in the projection region 106, which is spaced apart from the projection unit 101 by the larger distance, the safety of users can be ensured by setting the set luminance to be lower than the maximum luminance of the projection light 102 emitted by the projection unit 101, the maximum luminance being determined by the maximum allowable exposure light output corresponding to the distance from the projection unit 101.

In the second embodiment, effects similar to those of the first embodiment can be obtained.

### Third Embodiment

A third embodiment of the present disclosure will now be described in detail with reference to FIG. 5. FIG. 5 is a diagram illustrating projection performed onto a projection target 203 by a projector apparatus according to the third embodiment. The difference between the third embodiment and the above-described embodiments is that a projection surface of the projection target 203 is positioned so as to be inclined with respect to the optical axis of projection light 202.

As illustrated in FIG. 5, the projection light 202 that is emitted from an emitting end of a projection unit 201 of the projector apparatus is projected on the projection target 203. The distance-measuring unit 204 that measures the distance from the emitting end of the projection unit 201 to the projection target 203 is built in the projection unit 201.

Here, the distance-measuring unit 204 measures the distance from the emitting end of the projection unit 201 to each portion of the projection surface of the projection target 203, and a shortest distance L21 is set. The luminance of the projection unit 201 is adjusted in such a manner that the output of the projection light 202 becomes a level at which safety can be ensured with respect to the shortest distance L21.

More specifically, the luminance of the projection light 202 to be projected onto a portion that is spaced apart from the projection unit 201 by a distance that is measured by the distance-measuring unit 204 and that is larger than the shortest distance L21 is increased by the control unit 24 (see FIG. 2) so as not to exceed the set luminance of the projection light 202.

Thus, by increasing the luminance of the projection light 202 to be projected onto a portion that is spaced apart from the projection unit 201 by a distance larger than the shortest distance L21 such that the luminance does not exceed the set luminance of the projection light 202, a projector apparatus capable of ensuring the safety of the projection light 202 to be projected onto a portion that is spaced apart from the projection unit 201 by a distance larger than the shortest distance L21 can be provided.

### Fourth Embodiment

A fourth embodiment of the present disclosure will now be described in detail with reference to FIG. 6. FIG. 6 is a diagram illustrating projection performed onto a projection target 303 by a projector apparatus according to the fourth embodiment.

The difference between the fourth embodiment and the above-described embodiments is that a distance-measuring unit 304 is disposed near a projection unit 301.

As illustrated in FIG. 6, projection light 302 that is emitted from an emitting end of the projection unit 301 is projected on the projection target 303. The distance-measuring unit 304 measures the distance from the distance-measuring unit 304 to the projection target 303, and the luminance of the projection unit 301 is adjusted in such a manner that the output of the projection light 302 becomes a level at which safety can be ensured with respect to a shortest distance L31.

Thus, by increasing the luminance of the projection light 302 to be projected onto a portion that is spaced apart from the projection unit 301 by a distance larger than the shortest distance L31 such that the luminance does not exceed the set luminance of the projection light 302, a projector apparatus capable of ensuring the safety of the projection light 302 to be projected onto a portion that is spaced apart from the projection unit 301 by a distance larger than the shortest distance L31 can be provided.

In addition, since the distance-measuring unit 304 and the projection unit 301 can be arranged independently of each other, it is not necessary to change the structure of the projection unit 301 and the structure of the distance-measuring unit 304, and thus, the system can be constructed relatively easily.

### Fifth Embodiment

A fifth embodiment of the present disclosure will now be described in detail with reference to FIG. 7. FIG. 7 is a diagram illustrating projection performed onto a projection target 403 by a projector apparatus according to the fifth embodiment.

The differences between the fifth embodiment and the above-described embodiments are that irregularities are formed on a projection surface of the projection target 403 and that a plurality of distance-measuring units are arranged near a projection unit 401. Here, as an example, a distance-measuring unit 404 and a distance-measuring unit 405 are arranged on opposite sides of the projection unit 401.

Projection light 402 that is emitted from an emitting end of the projection unit 401 is projected on the projection target 403. Here, the distance-measuring unit 404 measures a shortest distance L41 from the distance-measuring unit 404 to the projection target 403, and the distance-measuring unit 405 measures a shortest distance L42 from the distance-measuring unit 405 to the projection target 403. The luminance of the projection unit 401 is adjusted in such a manner that the output of the projection light 402 becomes a level at which safety can be ensured with respect to the shortest distance L42, which is smaller than the shortest distance L41.

Thus, by increasing the luminance of the projection light 402 to be projected onto a portion that is spaced apart from the projection unit 401 by a distance larger than the shortest distance L42 such that the luminance does not exceed the set luminance of the projection light 402, a projector apparatus capable of ensuring the safety of the projection light 402 to be projected onto a portion that is spaced apart from the projection unit 401 by a distance larger than the shortest distance L42 can be provided.

By providing a plurality of distance-measuring units, the shortest distance to a projection target can be calculated from a plurality of distance data items, and thus, an improvement in the accuracy of distance measurement can be achieved. In addition, by using distance-measuring sensors employing different methods in a plurality of distance-measuring units and by selecting an optimum distance-measuring sensor in accordance with the surface profile or the surface state of the projection target 403, an improvement in the accuracy of distance measurement can be achieved.

### Sixth Embodiment

A sixth embodiment of the present disclosure will now be described in detail with reference to FIG. 8. FIG. 8 is a diagram illustrating projection performed onto a projection target 503 by a projector apparatus according to the sixth embodiment. The difference between the sixth embodiment and the above-described embodiments is that a shielding object 505 is interposed between a projection unit 501 and the projection target 503.

As illustrated in FIG. 8, in the case where the shielding object 505 is interposed between the projection unit 501 and the projection target 503, projection light 502 emitted by the projection unit 501 is projected on the shielding object 505. A distance-measuring unit 504 measures a distance L51 from the projection unit 501 to the shielding object 505, and the set luminance is set to a maximum luminance at which safety is ensured. In the case where the shielding object 505 is removed, and an image is projected onto the projection target 503, the luminance of the projection light 502 emitted by the projection unit 501 is increased to the set luminance of the projection light 502, at which the safety of users is ensured, in accordance with the distance to the projection target 503, so that the brightness of the projected image and the safety are both ensured.

In the above-described first embodiment, an optical triangulation sensor or a time of flight (TOF) sensor is applicable to the distance-measuring sensor 20 of the distance-measuring unit.

Although a projector apparatus that employs a laser-beam scanning system has been described in each of the above-described embodiments, a projector apparatus that employs a spatial modulation system is also applicable within the scope of the present disclosure.

In addition, as described above, the projector apparatuses described in the above embodiments can be used for image projection and projection mapping. [Implementation Example with Software]

A control block (particularly the control unit 24) of the projector apparatus may be fabricated by using a logic circuit (hardware) formed in, for example, an integrated circuit (an IC chip) or may be fabricated by using software.

In the latter case, the projector apparatus includes a computer that executes an instruction of a program, which is software that implements each function. The computer includes, for example, at least one processor (control device) and at least one computer-readable recording medium in which the above-mentioned program is stored. In the above-mentioned computer, the processor reads the above-mentioned program from the above-mentioned recording medium and runs the program, so that an object of the present disclosure is achieved. As the above-mentioned processor, for example, a central processing unit (CPU) can be used. As the recording medium, a “non-transitory tangible medium” such as, for example, a read only memory (ROM), a tape, a disk, a card, a semiconductor memory, a programmable logic circuit, or the like can be used. The computer may further include, for example, random access memory (RAM) into which the program is expanded. In addition, the program may be provided to the computer through an arbitrary transmission medium (such as a communication network or a broadcast wave) that is capable of transmitting the program. Note that an aspect of the present disclosure can also be implemented in the form of a data signal embedded in a carrier wave in which the program is embodied by electronic transmission.

### SUMMARY

The projector apparatus according to the first aspect of the present disclosure includes the projection unit (1, 101, 201, 301, 401, 501) that projects an image onto the projection target (3, 103, 203, 303, 403, 503), the distance-measuring unit (4, 104, 204, 304, 404, 405, 504) that measures the distance from the emitting end of the projection unit to the projection target, and the control unit (24) that sets the luminance of the projection light (2, 102, 202, 302, 402, 502) to a predetermined constant value when the distance measured by the distance-measuring unit is equal to or smaller than a predetermined distance and increases the luminance of the projection light such that the luminance does not exceed the set luminance of the projection light corresponding to the measured distance when the distance measured by the distance-measuring unit is larger than the predetermined distance.

According to the above-described configuration, a projector apparatus capable of suppressing a decrease in the brightness of a projected image and ensuring safety for users even when the distance from the projection unit of the projector apparatus increases can be provided.

In the projector apparatus according to the second aspect of the present disclosure, in the above-described first aspect, the distance-measuring unit may measure the distance to each portion of the projection target, and the control unit may increase the luminance of the projection light that is projected onto a portion of the projection target, the portion being spaced apart from the emitting end of the projection unit by a distance that is measured by the distance-measuring unit and that is larger than the predetermined distance, such that the luminance does not exceed the set luminance of the projection light.

According to the above-described configuration, an effect similar to that of the first aspect is obtained.

In the projector apparatus according to the third aspect of the present disclosure, in the above-described first or second aspect, the predetermined distance may be 300 mm or larger and 400 mm or smaller.

According to the above-described configuration, the set luminance is set to be constant when the distance from the projection unit of the projector apparatus to the projection target is equal to or smaller than the predetermined distance, and the luminance of the projection light is increased when the distance from the projection unit of the projector apparatus to the projection target is larger than the predetermined distance, so that an effect similar to that of the first aspect is obtained.

In the projector apparatus according to the fourth aspect of the present disclosure, in any one of the above-described first to third aspect, an increase rate at which the control unit increases the luminance of the projection light for a distance larger than the predetermined distance may be 0.02 lumens/mm or greater and 0.03 lumens/mm or less.

According to the above-described configuration, an effect similar to that of the third aspect is obtained.

In the projector apparatus according to the fifth aspect of the present disclosure, in any one of the above-described first to fourth aspect, the control unit may set a set luminance of the projection light for each distance corresponding to a distance that is measured by the distance-measuring unit and that is larger than the predetermined distance to be, at a maximum, 90% of a maximum allowable luminance that is larger than the set luminance for the distance.

According to the above-described configuration, a projector apparatus capable of suppressing a decrease in the brightness of a projected image and ensuring safety for users with higher certainty even when the distance from the projection unit of the projector apparatus increases can be provided.

In the projector apparatus according to the sixth aspect of the present disclosure, in any one of the above-described first to fourth aspect, when a shielding object is interposed between the emitting end and the projection target, the control unit may set the set luminance that corresponds to the shortest distance from the emitting end to the shielding object. when the shielding object is removed, and the image is projected on the projection target, the control unit may increase the luminance of the projection light such that the luminance does not exceed the set luminance corresponding to the distance to the projection target.

According to the above-described configuration, an effect similar to that of the first aspect is obtained.

In the projector apparatus according to the seventh aspect of the present disclosure, in any one of the above-described first to sixth aspect, the projector apparatus may be a projector apparatus that employs a laser-beam scanning system.

In the projector apparatus according to the eighth aspect of the present disclosure, in any one of the above-described first to seventh aspect, the projection unit and the distance-measuring unit may be arranged close to each other.

In the projector apparatus according to the ninth aspect of the present disclosure, in any one of the above-described first to eighth aspect, the distance-measuring unit may be one of a plurality of distance-measuring units included in the projector apparatus.

A method for controlling a projector apparatus according to the tenth aspect of the present disclosure includes projecting an image on a projection target, measuring a distance from an emitting end of a projection unit, which is used in the projecting, to the projection target, and setting a luminance of projection light to a predetermined constant value when a distance measured in the measuring is equal to or smaller than a predetermined distance and increasing the luminance of the projection light such that the luminance does not exceed a set luminance of the projection light corresponding to the distance measured in the projecting when the measured distance is larger than the predetermined distance.

According to the above-described configuration, an effect similar to that of the first aspect is obtained.

The present disclosure is not limited to the above-described embodiments, and various modifications can be made within the scope of the claims. Embodiments that are obtained by suitably combining the technical measures disclosed in the different embodiments are also within the technical scope of the present disclosure. In addition, a new technical feature can be obtained by combining the technical measures disclosed in the embodiments.

The present disclosure contains subject matter related to that disclosed in Japanese Priority Patent Application JP 2019-203449 filed in the Japan Patent Office on Nov. 8, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A projector apparatus comprising:
a projection unit that projects an image on a projection target;
a distance-measuring unit that measures a distance from an emitting end of the projection unit to the projection target; and
a control unit that sets a luminance of projection light to a predetermined constant value when a distance measured by the distance-measuring unit is equal to or smaller than a predetermined distance and increases the luminance of the projection light such that the luminance does not exceed a set luminance of the projection light corresponding to the measured distance when the distance measured by the distance-measuring unit is larger than the predetermined distance.

2. The projector apparatus according to claim 1,
wherein the distance-measuring unit measures a distance to each portion of the projection target, and
wherein the control unit increases the luminance of the projection light that is projected on a portion of the projection target, the portion being spaced apart from the emitting end of the projection unit by a distance that is measured by the distance-measuring unit and that is larger than the predetermined distance, such that the luminance does not exceed the set luminance of the projection light.

3. The projector apparatus according to claim 1,
wherein the predetermined distance is 300 mm or larger and 400 mm or smaller.

4. The projector apparatus according to claim 1,
wherein an increase rate at which the control unit increases the luminance of the projection light for a distance larger than the predetermined distance is 0.02 lumens/mm or greater and 0.03 lumens/mm or less.

5. The projector apparatus according to claim 1,
wherein the control unit sets a set luminance of the projection light for each distance corresponding to a distance that is measured by the distance-measuring unit and that is larger than the predetermined distance to be, at a maximum, 90% of a maximum allowable luminance that is larger than the set luminance for the distance.

6. The projector apparatus according to claim 1,
wherein, when a shielding object is interposed between the emitting end and the projection target, the control unit sets the set luminance that corresponds to a shortest distance from the emitting end to the shielding object, and when the shielding object is removed, and the image is projected on the projection target, the control unit increases the luminance of the projection light such that the luminance does not exceed the set luminance corresponding to a distance to the projection target.

7. The projector apparatus according to claim 1,
wherein the projector apparatus is a projector apparatus that employs a laser-beam scanning system.

8. The projector apparatus according to claim 1,
wherein the projection unit and the distance-measuring unit are arranged close to each other.

9. The projector apparatus according to claim 1,
wherein the distance-measuring unit is one of a plurality of distance-measuring units included in the projector apparatus.

10. A method for controlling a projector apparatus, the method comprising:
projecting an image on a projection target;
measuring a distance from an emitting end of a projection unit, which is used in the projecting, to the projection target; and
setting a luminance of projection light to a predetermined constant value when a distance measured in the measuring is equal to or smaller than a predetermined distance and increasing the luminance of the projection light such that the luminance does not exceed a set luminance of the projection light corresponding to the distance measured in the projecting when the measured distance is larger than the predetermined distance.

11. A non-transitory computer-readable recording medium in which a program is recorded, wherein the program for causing a computer to function as the projector apparatus according to claim 1, the program causing the computer to function as the projection unit, the distance-measuring unit, and the control unit.
